(19) United States
(12) Patent Application Publication
(10) Pub. No.: US 2010/0287109 A1
(43) Pub. Date: Nov. 11, 2010

(54) Linking Software Users Sharing Common Traits

(75) Inventors: Juan Jenny Li, Basking Ridge, NJ (US); David Mandel Weiss, Long Valley, NJ (US)

Correspondence Address: Avaya;DEMONT & BREYER, LLC, 100 COMMONS WAY, STE 250, HOLMDEL, NJ, 07733, US

(73) Assignee: AVAYA INC., Basking Ridge, NJ (US)

(21) Appl. No.: 12/463,128

(22) Filed: May 8, 2009

(51) Int. Cl. G06Q 99/00; G06Q 50/00

(52) U.S. Cl. 705/319

(57) ABSTRACT

A method for the establishing of connections between software users based on a pattern of use and/or a characteristic of content related to the users and the software. The interaction of a software user with the software is monitored and a characteristic of content related to the user and the software is determined. When the user needs customer support, he or she is routed to a fellow user of the same software who is capable of providing help. The helping user is selected based on the way in which the first user interacts with the software and/or the characteristic of content related to the first user and the software.

### FIELD OF THE INVENTION

The present invention relates to telecommunications in general, and, more particularly, to methods for initiating telecommunications sessions.

### BACKGROUND OF THE INVENTION

Software companies devote vast resources for office space, training, and payroll of customer support technicians. Despite such expenses, it remains impossible for them to provide one-on-one service in a timely manner to the millions of users of their software. This is why software companies have adopted various approaches for reducing the number of customer service calls that they receive.

One such approach is to provide extensive documentation with software releases. When a software user has a question about the software, he or she is given the opportunity to search the software documentation and find the answer there. However, there is always the possibility that the documentation will not contain the answer. While software documentation can effectively expose the general functionality of a software program, it is not well-suited for answering pointed questions about the software. For this reason, some software vendors also ship their software with a so-called “virtual assistant.”

A virtual assistant is a program that attempts to answer specific questions that are asked by the user in a conversational manner. Ideally, when a user types “How do I change the color of the background of a table cell?” the virtual assistant would provide the user with a set of steps that the user can perform in order to execute the task specified. However, because of the complexity of parsing and understanding human natural language, virtual assistants often fail to provide the right answer to user queries.

Therefore a need exists for an improved way of providing customer service for software applications and electronic devices that are used by large numbers of people.

### SUMMARY OF THE INVENTION

The present invention addresses this need by providing a solution for delivering customer support without some of the costs and disadvantages of the prior art.

Some embodiments of the present invention provide a method for the establishing of connections between software users based on a pattern of use and/or a characteristic of content related to the users and the software. The interaction of a software user with the software is monitored and a characteristic of content related to the user and the software is determined. When the user needs customer support, he or she is routed to another user of the same software who is capable of providing help. The helping user is selected based on the way in which the first user interacts with the software and/or the characteristic of content related to the first user and the software.

For the purposes of this disclosure, the phrase “characteristic of content,” and its inflected forms, is defined as any property of any input to a software application or device.

For example, the present invention can be used in a situation in which a programmer is using a software testing tool to test computer source code. In accordance with the illustrative embodiment, the use of the testing tool by the programmer is monitored, and his or her skill level at using the testing tool determined. Complexity metrics of the tested software, which are one example of characteristics of content, are evaluated and conclusions about the complexity of the tested software drawn. These conclusions are used by some embodiments of the present invention as a measure of the technical expertise of the programmer.

When the programmer is in need of assistance, he or she is connected with another programmer of similar or better proficiency in using the software testing tool and/or similar or better programming skills. Because of the common grounds between the two programmers, the second programmer is more likely to feel inclined to respond to the request for help.

The present invention benefits the vendors of software greatly. It allows software vendors to reduce the number of customer service representatives they employ, thereby reducing the vendors' operating costs and increasing their profits. It also benefits consumers by providing a better way of customer service allowing users to obtain help without having to wait for a customer support representative to become available. And more importantly, the present invention allows users to obtain answers to specific questions without having to read through pages of help manuals or struggle with unresponsive virtual assistants.

Although some embodiments of the present invention are described in the context of providing customer service to software users, it is to be understood that the uses and applications of the methods and principles described in this disclosure extend well beyond the service of clients of the software industry to virtually any field in which users of a product can benefit from the knowledge of other users of the same product.

### BRIEF DESCRIPTION OF THE DRAWINGS

FIG. 1 depicts a schematic diagram of the salient components of the illustrative embodiment of the present invention.

FIG. 2 depicts a flowchart of the salient tasks associated with the illustrative embodiment of the present invention.

FIG. 3 depicts a flowchart of the salient subtasks involved in the execution of task 207 in accordance with one illustrative embodiment.

FIG. 4 depicts a schematic diagram of the salient components of the operation of an illustrative embodiment of the present invention as used in the field of computer gaming.

FIG. 5 depicts a schematic diagram of the salient components of the operation of an illustrative embodiment of the present invention as used in the field of software development.

### DETAILED DESCRIPTION

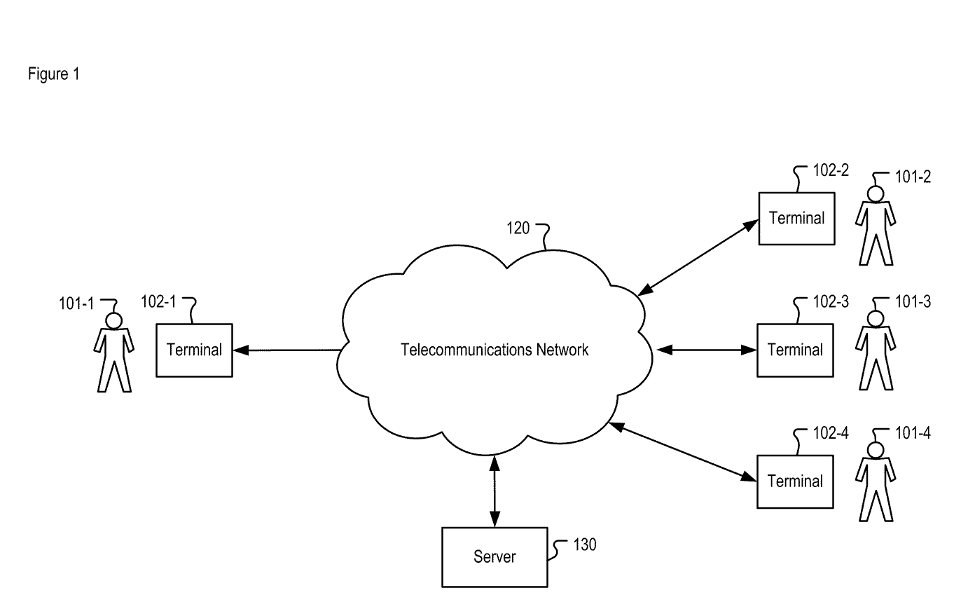

FIG. 1 depicts a schematic diagram of the salient components of the illustrative embodiment of the present invention. The illustrative embodiment comprises: user 101-i, terminal 102-i, wherein i∈{1, 2, 3, 4}, server 130, and telecommunications network 120.

User 101-i, is a natural person using terminal 102-i, in well-known fashion.

Terminal 102-i is a data processing system connected to telecommunications network 120 via a wireline, in well-known fashion. In accordance with the illustrative embodiment terminal 102-i is running a software application which user 101-i uses. Although terminal 102-i is connected to telecommunications network 120 via a wireline, it will be clear to those skilled in the art, after reading this disclosure, how to make and use alternative embodiments of the present invention in which terminal 102-i is connected to telecommunications network 120 via another technology, such as, for example and without limitation, a wireless connection. In accordance with the illustrative embodiment of the present invention, terminal 102-i is a general purpose computer, but it will be clear to those skilled in the art, after reading this disclosure, how to make and use alternative embodiments of the present invention in which terminal 102-i is another electronic device (e.g. cellular telephone, 2-way radio, desk-set telephone, portable digital assistant, television receiver, stereo receiver, television set, electronic game console, mp3 player, etc.)

Server 130 is hardware and software for processing information about user 101-i. In accordance with the illustrative embodiment, server 130 is running social networking software capable of creating, maintaining, and interrelating user profiles, but it will be clear to those skilled in the art, after reading this disclosure, how to make and use alternative embodiments of the present invention in which server 130 is running any kind of software (e.g. database software containing user information, voice telecommunications software, instant messaging software, etc.).

Telecommunications network 120 transports signals between terminals 102-i. In accordance with the illustrative embodiment of the present invention, telecommunications network 120 is the Internet, but it will be clear to those skilled in the art, after reading this disclosure, how to make and use alternative embodiments of the present invention in which telecommunications network 120 is another telecommunications network (e.g. the Public Switched Telephone Network, cellular telephone network, etc.).

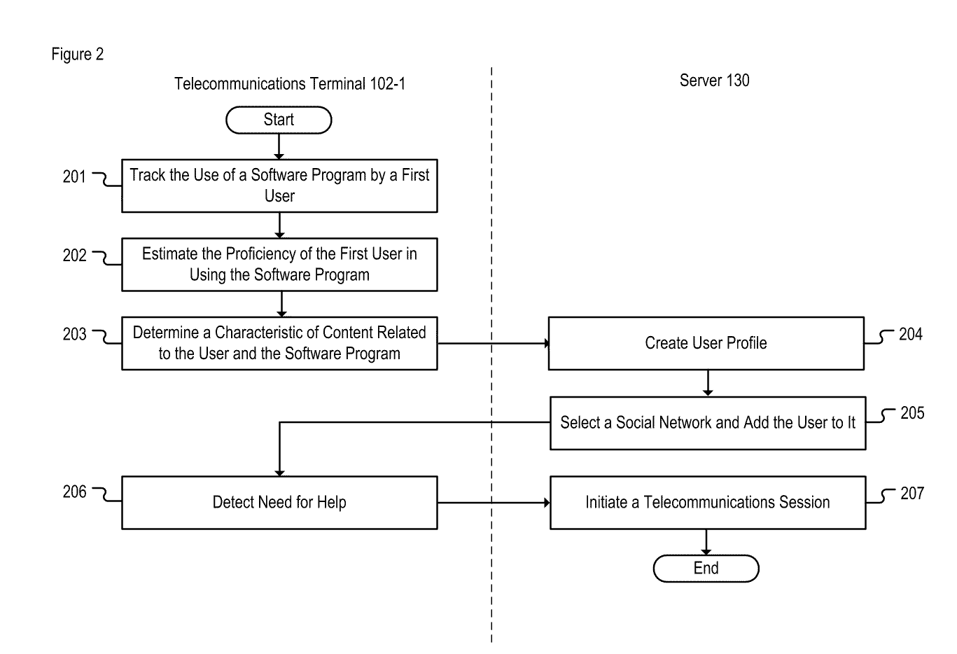

FIG. 2 depicts a flowchart of the salient tasks associated with the operation of the illustrative embodiment of the present invention. It will be clear to those skilled in the art, after reading this disclosure, how to perform the tasks associated with FIG. 2 in a different order than represented or to perform the one or more of the tasks concurrently. Furthermore, it will be clear to those skilled in the art, after reading this disclosure, how to make and use alternative embodiments of the present invention that omit one or more of the tasks. Furthermore, it will be clear to those skilled in the art, after reading this disclosure, how to make and use alternative embodiments of the present invention in which tasks performed by server 130 are performed by terminal 102-i (singularly, or in distributed fashion), and vice versa.

At task 201, the interaction of user 101-1 with a software application running on terminal 102-1 is monitored. In accordance with the illustrative embodiment of the present invention, the monitoring is performed by the software application itself, but it will be clear to those skilled in the art, after reading this disclosure, how to make and use alternative embodiments in which the monitoring is performed by one or more other applications that are independent from the software application monitored.

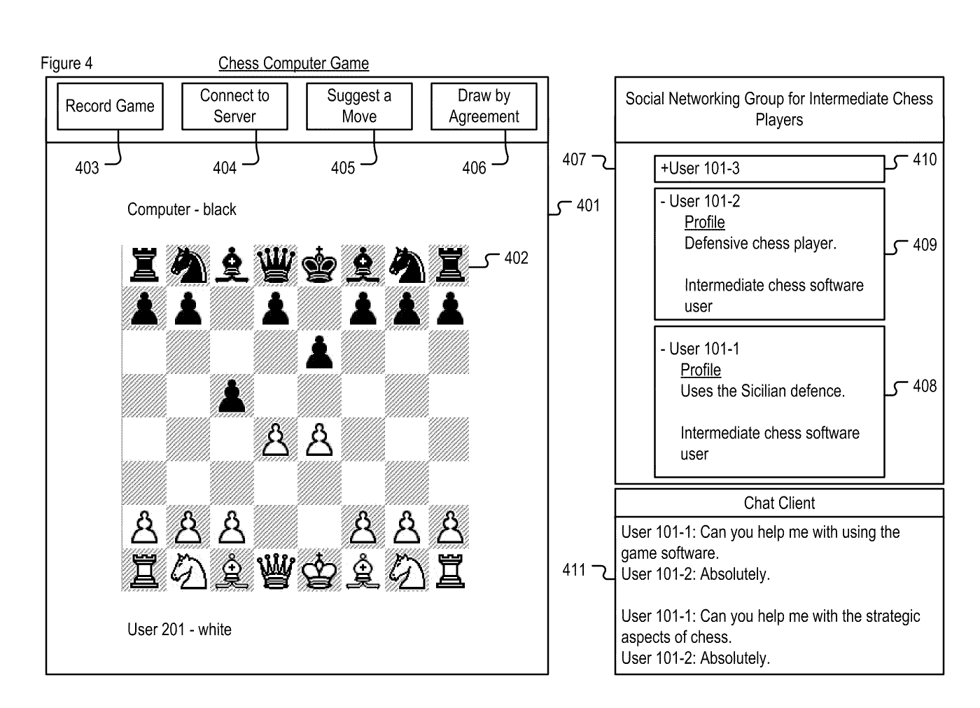

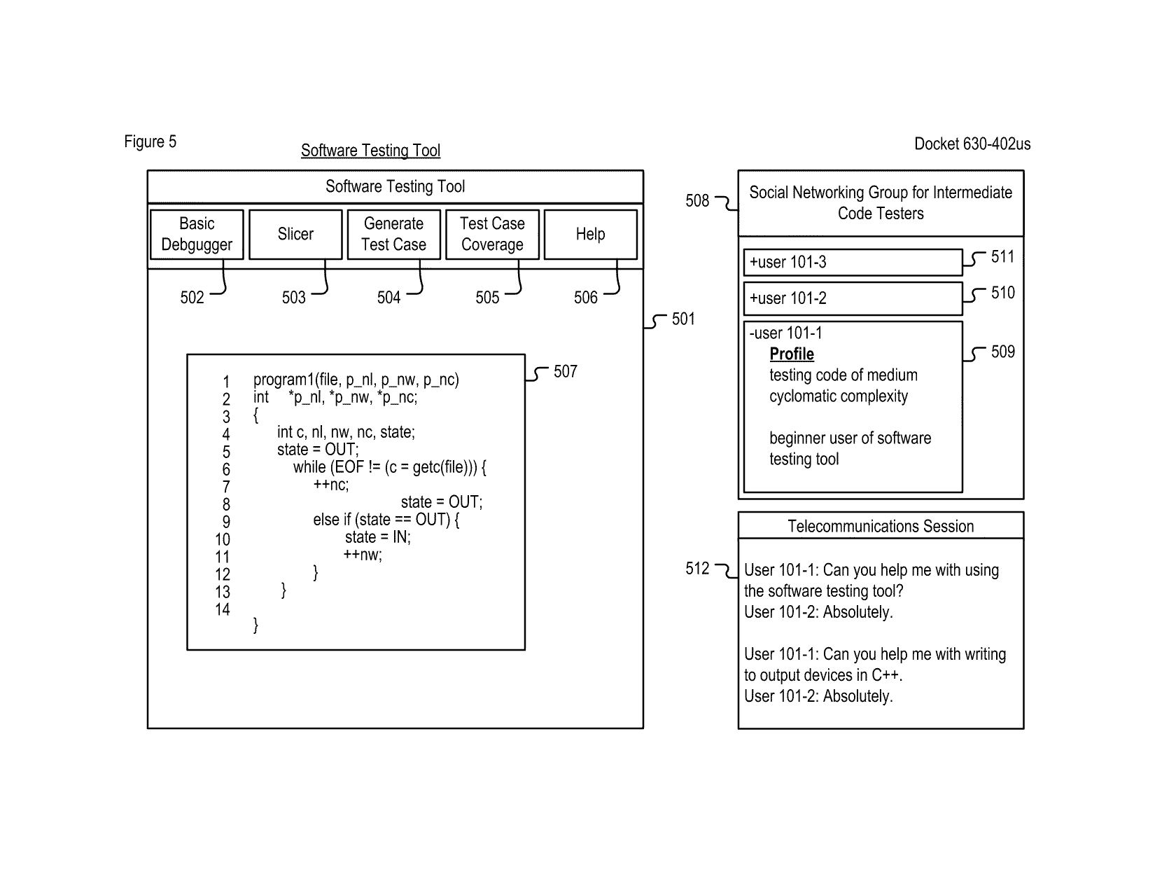

Furthermore, in accordance with the illustrative embodiment, the monitoring involves measuring the frequency at which user 101-1 invokes different application features. However, it will be clear to those skilled in the art, after reading this disclosure, how to make and use alternative embodiments of the present invention in which other metrics of the user interaction with the software are measured, such as, for example, and without limitation, the order in which specific application features are invoked, time delay between the invocation of individual application features, a preference by the user to invoke some features over others, and so forth. Although in the illustrative embodiment, the invocation of software application features by user 101-1 is monitored, it will be clear to those skilled in the art, after reading this disclosure, how to make and use alternative embodiments of the present invention in which the execution of sections of software application code in the course of running the software application is monitored instead. Further examples of the monitoring of the interaction of user 101-1 with the software application are provided in the discussions with respect to FIGS. 4 and 5.

Although in the illustrative embodiments of the present invention, the user interaction with a software application is monitored, it will be clear to those skilled in the art, after reading this disclosure, how to make and use alternative embodiments of the present invention in which the interaction of a user with a consumer electronic device is monitored, such as, for example, and without limitation, the interaction of a television viewer with a television set remote control, the interaction of a cellular telephone user with the cellular telephone number pad, and so forth. In any event, one skilled in the art will recognize that most consumer electronic devices run some type of software, and in many cases monitoring the interaction of the user with the electronic device is equivalent to monitoring the user's interaction with the software running on the device. However, it will be clear to those skilled in the art, after reading this disclosure, how to make and use alternative embodiments of the present invention in which entirely physical aspects of the user interaction with the device are monitored, such as, for example, and without limitation, the humidity to which the user exposes the device, the temperature to which the user exposes the device, the acceleration/deceleration to which the user exposes the device, the vertical orientation of the device when used by a user, the shaking of the device, the dropping of the device on the ground, etc.

At task 202, user 101-1 is categorized based on his or her interaction with the software application. In accordance with the illustrative embodiment, the user is categorized according to his or her proficiency in using the software application. The proficiency is estimated based on the user interactions with the software application running on terminal 102-1. The estimation is based on predetermined patterns of use that are indicative of the user's proficiency. Such patterns of use could be the invocation of a specific feature, or the sequence of use of specific features. In accordance with the illustrative embodiment, the proficiency of user 101-1 is determined once, but it will be clear to those skilled in the art, after reading this disclosure, how to make and use alternative embodiments of the present invention in which the estimation of the user proficiency is dynamically updated (e.g. every five minutes, after the performance of a task, etc.). Those skilled in the art will appreciate, after reading this disclosure, that a variety of metrics for the assessment of user proficiency can be established, such as, for example, and without limitation, speed at which a user invokes application features, diversity of application features invoked, the use of specific application features, etc.

Furthermore, it will be clear to those skilled in the art, after reading this disclosure, how to make and use alternative embodiments of the present invention in which users are categorized according to any aspect of their interaction with a software application or device (e.g. how often the user drops a device, how often the user shakes a device, how often a particular application feature is invoked by the user, how often a sequence of software features is invoked, how often a particular section of program code executes, etc.). And still furthermore, it will be clear to those skilled in the art, after reading this disclosure, how to make and use alternative embodiments of the present invention in which users are categorized according to the computing resources available to them, such as, for example, and without limitation, type of operating system, speed of computer, amount of system memory available, etc.

At task 203, a characteristic of content related to the software application running on terminal 102-1 and user 101-1 is determined. Content is any input entered into the software, such as, and without limitation, a text opened in a word processor, source code loaded into a software testing tool, the moves made by a chess player, etc. And a characteristic of the content is any property of the input, such as, and without limitation, file size, genre of a novel edited by a word processor, genre of a computer game developed in an integrated development environment, genre of music edited by music editing software, rhythm of music edited by music editing software, length of input file size, type of input file size, cyclomatic complexity of program source code, etc. Examples of characteristics of content related to user 101-1 and a software application are further provided in the discussions with respect to FIGS. 4 and 5.

At task 204, server 130 creates, in a well-known fashion, a profile for user 101-1 that comprises the information obtained at tasks 201, 203, and 204. The user profile is a record of user-specific data for user 101-1 that defines the user in a social network. In accordance with the illustrative embodiment, the user profile is created once, but it will be clear to those skilled in the art, after reading this disclosure, how to make and use alternative embodiments of the present invention in which the user profile is dynamically updated (e.g. every five minutes, after the performance of a task, etc.). Those skilled in the art will appreciate, after reading this disclosure, that the content of the user profile is not limited to the information gathered at tasks 201 through 203, and that the user profile can contain any information that is deemed useful in identifying and distinguishing user 101-1, such as, for example, and without limitation, online presence status (busy, offline, online, etc.), gender, profession, name, employer, experience, and so forth. Also, those skilled in the art will appreciate, after reading this disclosure, that the user profile can simply serve to identify the user from a group of other users, and it need not necessarily be tied to a social network. Further examples of user profiles are provided in the discussions with respect to FIGS. 4 and 5.

At task 205, server 130 selects a social network to which the profile of user 101-1 is to be added. In accordance with the illustrative embodiment all users of the software application are added to the same social network, but it will be clear to those skilled in the art, after reading this disclosure, how to make and use alternative embodiments of the present invention in which different users are added to different social networks (e.g. advanced users added to social networks for advanced users). Furthermore, it will be clear to those skilled in the art, after reading this disclosure, that the selection of the social network, can be based on any item of information found in the profile of user 101-1, such as, for example, and without limitation, a characteristic of content related to the user and the software application (e.g. the application is a word processor, the user uses it to write poetry in iambic pentameter, so the user is added to a social network for poets who are skilled in composing poems in this meter), proficiency of the user in using the software application, proficiency of the user in manipulating the content in relation to which the software application is used (e.g. the software application is a word processor, the user is a seasoned writer, so the user is added to a social network for seasoned writers), age, gender, profession, specific patterns of use of the software application (e.g. user invokes some program features frequently while never using others, user invokes features in a specific sequence, etc.), and so forth.

At task 206, the software application running on terminal 102-1 detects that user 101-1 needs assistance. In accordance with the illustrative embodiment, need for assistance with respect to using the software application is detected, but it will be clear to those skilled in the art, after reading this disclosure, how to make alternative embodiments of the present invention in which terminal 102-1 detects that user 101-1 needs assistance with respect to content related to the software application and the user, or both content and using the software application. For example, and without limitation, a word processor might detect that the user needs help in writing poetry, a cellular phone software might detect that the user needs help in sending properly formatted Short Message Service (SMS) messages, etc.

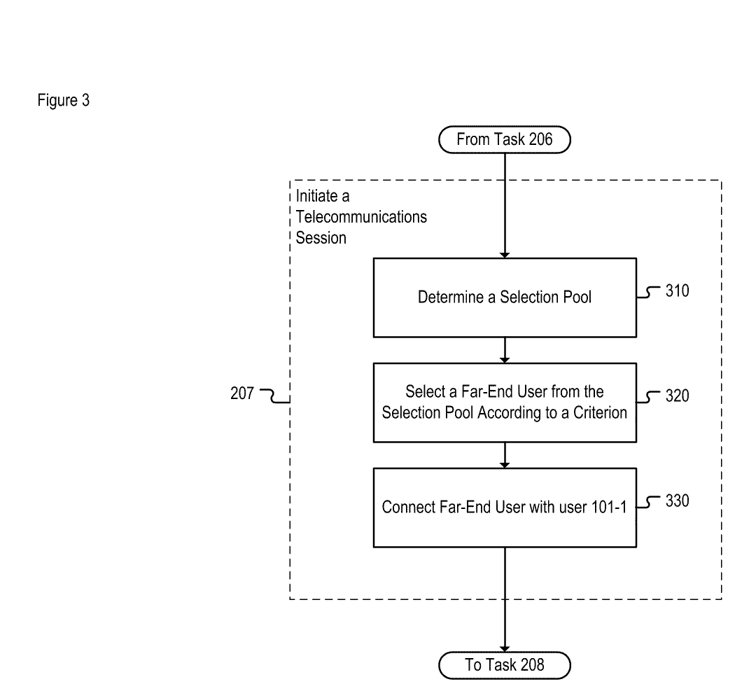

At task 207, a telecommunications session is initiated between user 101-1 and a far-end party. Task 207 is further discussed with respect to FIG. 3.

FIG. 3 depicts a flowchart of the salient subtasks involved in the execution of task 207. It will be clear to those skilled in the art, after reading this disclosure, how to perform the tasks associated with FIG. 3 in a different order than represented, to perform the tasks simultaneously, or omit one or more of the tasks.

At task 310, a selection pool is determined from which a far-end party for a telecommunications session between the far-end party and user 101-1 is to be selected. In accordance with the illustrative embodiment of the present invention, the selection pool comprises all members of the social network to which the profile of user 101-1 is added at task 205. However, it will be clear to those skilled in the art, after reading this disclosure, how to make and use alternative embodiments of the present invention in which a social network is not used, and in which the selection pool comprises, for example, and without limitation, all persons present in a simple list of “names” hosted on server 130, the people present inside a computer chat room, users of a software application that are logged on at a given time instant, people registered on a website, and so forth. Furthermore, it will be clear to those skilled in the art, after reading this disclosure, how to make and use alternative embodiments of the present invention in which the selection pool is determined by sending a query, such as a help request, for example, to one or more potential far-end parties and including one or more of the potential far-end parties in the selection pool based on their responses to the query.

At task 320, a far-end party is selected from the selection pool determined at task 310 according to a selection criterion. In accordance with the illustrative embodiment, the selection criterion is based on the proficiency of the far-end party in the software application running on terminal 102-1, but it will be clear to those skilled in the art, after reading this disclosure, that the selection criterion can be based on any information found in the user profile for user 101-1 or the far-end party, such as, for example, and without limitation, a characteristic of content related to the user and a software application, age, gender, geographic location, professional affiliation, profession, professional experience, experience in using a software application, etc. Furthermore, in accordance with the illustrative embodiment of the present invention, only one far-end party is selected from the selection pool, but it will be clear to those skilled in the art, after reading this disclosure, how to make and use alternative embodiments of the present invention, in which multiple far-end parties are selected.

At task 330, a telecommunications session is established between user 101-1 and one or more far-end parties from the selection pool. In accordance with the illustrative embodiment, user 101-1 is placed in a computer chat room with the selected one or more far-end parties, but it will be clear to those skilled in the art, after reading this disclosure, how to make and use alternative embodiments of the present invention in which the telecommunications session is, for example, and without limitation, a telephone conversation, instant message exchange, Internet Relay Chat, email exchange, and others. It will be clear to those skilled in the art how to execute task 330.

FIG. 4 depicts a schematic diagram of the salient components of the operation of the illustrative embodiment of the present invention as used in the field of computer gaming. The illustrative embodiment comprises: chess interface 401, chat client interface 411, and social network interface 407.

Although, chess interface 401, social network interface 407, and chat client 411 are depicted as different components of the same software application, it will be clear to those skilled in the art, after reading this disclosure, how to make and use alternative embodiments of the present invention in which each component is implemented separately as an independent application. Furthermore, those skilled in the art will appreciate that each application can execute on a separate hardware platform from the others.

Chess interface 401 is the graphical user interface of a computer chess game running on terminal 102-1. Chess interface 401 comprises a graphical representation of a chessboard over which user 101-1 can move virtual chess figures. Additionally, chess interface 401 provides access to interactive features, such as game recording, connection to game servers, automatic move generation, and the ability to propose a draw by agreement. The features are accessed via record button 403, connect button 404, auto-move button 405, and draw button 406, respectively. In accordance with the illustrative embodiment, the use of one or more of the record, connect, auto-move, and draw features, by user 101-1, is an indication of the proficiency of user 101-1 in using the chess software application.

Record button 403 provides access to a game recording feature. The pressing of record button 403 results in the recording of a transcript of all moves made by user 101-1 and the computer. In accordance with the illustrative embodiment, only advanced users of the computer chess game are considered to be familiar with the record feature. It will be clear to those skilled in the art how to make and use record button 403.

Connect button 404 provides access to an online gaming feature that allows the users of the computer chess game to connect to an online game server where they can arrange to play against other human players. In accordance with the illustrative embodiment beginning users of the computer chess game are considered to be familiar with the online connectivity feature. It will be clear to those skilled in the art how to make and use connect button 404.

Auto-move button 405 provides access to a move generating feature. The pressing of auto-move button 101-1 causes the computer to make a move on behalf of the user. In accordance with the illustrative embodiment only intermediate and advanced users of the computer chess game are considered to be familiar with the move generating feature. It will be clear to those skilled in the art how to make and use auto-move button 405.

Draw button 406 allows user 101-1 to propose a draw by agreement. In accordance with the illustrative embodiment, beginning users of the computer chess game are considered capable of using the draw by agreement feature. It will be clear to those skilled in the art how to make and use draw button 406.

In accordance with the illustrative embodiment, the chess computer game keeps track of the interactions of user 101-1 with chess interface 401, and in particular, it measures the frequency at which user 101-1 invokes the connect feature, auto-move feature, and record feature. It will be clear to those skilled in the art how to make and use alternative embodiments of the present invention in which other metrics of the interaction between the user and software are monitored, such as, and without limitation, the order in which specific features are invoked, time delay between the invocation of individual features, a preference by the user to invoke some features over others, or any other pattern of use of the chess computer game.

Based on the user interactions with chess interface 401, the chess computer game evaluates the proficiency of user 101-1 in using the chess computer game. In accordance with the illustrative embodiment, user 101-1 is classified as an intermediate user of the chess computer game. The classification is based on the frequent use of the auto-move feature by user 101-1, and lack of use of the record feature.

Additionally, a characteristic of content related to user 101-1 and the chess game software is also determined by the chess computer game. In accordance with the illustrative embodiment, the characteristic of content detected is the use of the Sicilian defense by user 101-1. However, it will be clear to those skilled in the art, after reading this disclosure, how to make and use alternative embodiments of the present invention in which any characteristic of content is detected at task 403, such as, and without limitation, frequency of winning and losing by user 101-1, favorite opening move by user 101-1, frequency of castling and pawn promotion, specific moves by user 101-1, etc. Furthermore, it will be clear to those skilled in the art, after reading this disclosure, how to make and use alternative embodiments of the present invention in which the characteristic of content related to user 101-1 and the chess computer game is any metric of the chess game play of user 101-1, such as, and without limitation, quality of user game play during the beginning and final stages of the game, defensive posture of the user, how often user 101-1 makes moves which the computer believes to be optimal, and so forth.

Social network interface 407 is a graphical user interface for a social network. In accordance with the illustrative embodiment, the social network is for all users of the chess computer game, however it will be clear to those skilled in the art, after reading this disclosure, how to make and use alternative embodiments of the present invention in which the profile of user 101-1 is added to a social network with a more particularized membership base, such as, for example, and without limitation, a social network for advanced chess players, beginners, players who play chess defensively, players who start off their games well, but lag during the final stages, and so forth. Furthermore, it will be clear to those skilled in the art, after reading this disclosure, how to make and use alternative embodiments of the present invention in which the selection of the social network is based on any item of information found in the profile of user 101-1.

User profile 408 is a record of user-specific data for user 101-1 that defines the user in the social network. User profile 408 identifies user 101-1 as a chess player who uses the Sicilian defense. Also, user profile 408 indicates that user 101-1 is a user having an intermediate proficiency in using the chess computer game. In accordance with the illustrative embodiment, user profile 408 is based on information gathered over a single use session—over the time period beginning when the computer chess game is started, and ending when the game is shut down. However, it will be clear to those skilled in the art, after reading this disclosure, how to make and use alternative embodiments of the present invention in which the user profile is based on information gathered over longer periods of time, such as days, weeks, and so forth. Furthermore, it will be clear to those skilled in the art that the user profiles can be based on information obtained over periods shorted than a single use session, such as, and without limitation, the duration of one or more chess games, half hourly periods, etc. And still furthermore, those skilled in the art would also appreciate that the user profile can be dynamically updated when a predetermined event occurs, such as, for example, and without limitation, the performance of a particular task with the software, the invocation of particular software application feature, the changing of a characteristic of content related to the user and the chess computer game, etc.

User profile 409 is a record of user-specific data for user 101-2 that defines user 101-2 within the social network. User profile 409 identifies user 101-2 as a defensive chess player having an intermediate proficiency in using the computer chess game.

User profile 410 is a record of user-specific data that defines a user of the computer chess game within the social network. User profile 410 is collapsed such that only an identifier for the user is visible.

Chat client 411 is the graphical user interface for a chat client and it enables user 101-1 to have an online chat conversation with user 101-2 when the chess computer game detects that user 101-1 needs assistance. Although a chat conversation is initiated in the illustrative embodiment, it will clear to those skilled in the art how to make and use alternative embodiments of the present invention in which any other type of telecommunications session is initiated (e.g. telephone call, chat session between user 101-1 and other users, etc.) In accordance with the illustrative embodiment, the chess computer game detects that 101-1 needs help with his or her gameplay. In accordance with the illustrative embodiment, the hesitation of user 101-1 to make a move for more than three minutes serves as an indication that the user is in need of assistance. However, it will be clear to those skilled in the art, after reading this disclosure, how to make and use alternative embodiments of the present invention, in which the need for assistance is detected based on another triggering event, such as, and without limitation, the performance of the user in the game, the repeated making of the same mistakes by the user, the pressing of a button, requesting by the user, etc.

In accordance with the illustrative embodiment, user 101-2 is selected to provide user 101-1 with assistance because of the similarity of his profile to the profile of user 101-1. Because user profile 409 indicates that user 101-2 is a defensive chess player, and because user profile 408 indicates that user 101-1 is using the Sicilian defense, server 130 determines that two users would form a fitting pair for the purposes of user 101-2 helping user 101-1. Although user 101-1 is matched to user 101-2 based only on a single characteristic of content, related to the user 101-1 and the chess computer game, it will be clear to those skilled in the art, after reading this disclosure, how to make and use alternative embodiments of the present invention in which the decision to match the two users can be based on more than one characteristics of content. Furthermore, it will be clear to those skilled in art that the matching of the two users can be made on the basis of any item of information available in their user profiles.

FIG. 5 depicts a schematic diagram of the salient components of the operation of the illustrative embodiment of the present invention as used in the field of software development. The illustrative embodiment comprises: testing interface 501, social network interface 508, and chat client 512.

Testing interface 501 is the graphical user interface of a software testing tool running on terminal 102-1. Testing interface 501 allows user 101-1 to view source code 507 and access features, such as basic debugger, slicer, test case generator, test case coverage meter, and help feature. The features are accessed via debugger button 502, slicer button 503, test case generate button 504, coverage button 505, and help button 506, respectively. In accordance with the illustrative embodiment, the use of one or more of the basic debugger, slicer, test case generator, and help feature, by user 101-1, is an indication of the proficiency of user 101-1 in using the software testing tool.

Debugger button 502 provides access to a basic debugger. In accordance with the illustrative embodiment, inexperienced users of the software testing tool are considered to be familiar with the basic debugger. It will be clear to those skilled in the art how to make and use debugger button 502.

Slicer button 503 provides access to a test case slicer. In accordance with the illustrative embodiment, only intermediate and advanced users of the software testing tool are considered to be familiar with the slicer. It will be clear to those skilled in the art how to make and use slicer button 503.

Test case generate button 504 provides access to a test case generator. In accordance with the illustrative embodiment, only intermediate and advanced users of the software testing tool are considered to be familiar with the test case generator. It will be clear to those skilled in the art how to make and use slicer button 504.

Test case coverage button 505 provides access to a test case coverage meter. In accordance with the illustrative embodiment, only advanced users of the software testing tool are considered to be familiar with the test case coverage meter. It will be clear to those skilled in the art how to make and use the test case coverage meter.

Help button 506 allows the users of the software testing tool to obtain assistance with either using the testing tool or with debugging source code 507. In accordance with the illustrative embodiment, beginning users of the software testing tool are considered to be familiar with the help feature.

The interaction of user 101-1 with the software testing tool is monitored. In accordance with the illustrative embodiment, the software testing tool keeps track of the frequency at which user 101-1 uses the debugger, slicer, test case generator, and test coverage meter. However, it will be clear to those skilled in the art, after reading this disclosure, how to make and use alternative embodiments of the present invention in which other metrics of the interaction of user 101-1 with the software testing tool are measured, such as, and without limitation, the invocation of specific sequences of features, time delay between the invocation of different features, a preference by the user to invoke some features over others (e.g. debugger over slicer), etc.

The software testing tool evaluates the proficiency of user 101-1 in using the software testing tool based on the user's interactions with the tool. In accordance with the illustrative embodiment, the frequent use of the basic debugger and no other features by user 101-1 is an indication that user 101-1 is a beginner at using the software testing tool. However, it will be clear to those skilled in the art, after reading this disclosure, how to make and use alternative embodiments of the present invention in which user proficiency is determined according to other criteria, such as and without limitation, the time spent working with the software testing tool, order of invocation of the features of the software testing tool, and others.

The software testing tool also determines a characteristic of content related to user 101-1 and itself. In accordance with the illustrative embodiment, the characteristic of content is the cyclomatic complexity of the source code being tested by the software testing tool. However, it will be clear to those skilled in the art, after reading this disclosure, how to make and use alternative embodiments of the present invention, in which the characteristic of content is any source code metric, such as, and without limitation depth of nesting, number of lines of code, number of functions, programming language used, etc.

Source code 507 is program source code.

Social network interface 508 is a graphical user interface for a social network. Social network interface 508 allows user 101-1 to view the identities of the members of a social network and observe their profiles. In accordance with the illustrative embodiment, the social network is for users of the software testing tool who are using it to test code of at least medium complexity. However, it will be clear to those skilled in the art, after reading this disclosure, how to make and use alternative embodiments of the present invention in which the social network has a different member base, such as, for example, and without limitation, a social network for game designers, designers of business enterprise application, advanced programmers, beginning programmers, programmers testing code with a certain number of lines, depth of nesting, number of functions, frequent users of the software testing tool, etc. Social network interface 508 provides access to profiles 509, 510, and 511.

Profile 509 is a record of data for user 101-1 that defines the user within the social network. In accordance with the illustrative embodiment, user profile 509 identifies user 101-1 as a beginning user of the software testing tool. Also, profile 509 indicates that user 101-1 is testing source code of medium cyclomatic complexity.

Profile 510 is a record of data for user 101-2 that defines the user within the social network. Profile 510 is collapsed, such that only an identifier for the programmer is visible.

Profile 511 is a record of data for a user 101-3 that defines the user within the social network. Profile 511 is collapsed, such that only an identifier for the user is visible.

Chat client 512 is the graphical user interface for a chat client and it enables user 101-1 to carry an online chat conversation with user 101-2. Although in the illustrative embodiment the telecommunications session between user 101-1 is a chat session, it will be clear to those skilled in the art, after reading this disclosure, how to make and use alternative embodiments that utilize any type of telecommunications session available. (e.g. telephone conversation, exchange of Short Message Services, etc.) Furthermore, it will be clear to those skilled in the art, after reading this disclosure, how to make and use alternative embodiments of the present invention in which user 101-1 is placed in a computer chat room and connected with a plurality of other users instead of being connected with a single person only. In accordance with the illustrative embodiment of the present invention, user 101-1 and user 101-2 are matched because user 101-2 has equivalent or better proficiency in using the software testing tool than user 101-1, but it will be clear to those skilled in the art, after reading this disclosure, how to make and use alternative embodiments of the present invention in which the two users are matched on the basis of any item of information found in one or both of the user profiles.

It is to be understood that the disclosure teaches just examples of the illustrative embodiments and that many variations of the invention can easily be devised by those skilled in the art after reading this disclosure and that the scope of the present invention is to be determined by the following claims.

What is claimed is:

1. A method comprising:
initiating a telecommunications session between a user and at least one member of a social networking group;
wherein the social networking group is selected from a plurality of social networking groups based, at least in part, on a feature of a software application invoked by a user of the software application.

2. The method of claim 1 wherein selecting from the plurality of social networking groups is also based, at least in part, on an estimate of the user's proficiency with the software application.

3. The method of claim 1 wherein selecting from the plurality of social networking groups is also based, at least in part, on a characteristic of content related to the user and the software application.

4. The method of claim 3 wherein the content is computer-readable source code and the characteristic of the content is a code metric of the source code.

5. The method of claim 3 wherein content is computer-readable source code and the characteristic of the content is the nature of the source code causing the user difficulty.

6. The method of claim 3 wherein the content is a sequence of actions taken by the first user in playing a computer game.

7. A method comprising:
initiating a telecommunications session based, at least in part, on a characteristic of content related to a user and a software application, wherein the characteristic is related to a skill level of a user.

8. The method of claim 7 wherein the user is added to a social networking group based on the characteristic.

9. The method of claim 8 wherein the user telecommunications session is between the user and another member of the social networking group.

10. The method of claim 7 wherein the content is computer-readable source code and the characteristic of the content is a code metric of the source code.

11. The method of claim 7 wherein the content is a sequence of actions taken by the first user in playing a computer game.

12. The method of claim 7 wherein initiating the telecommunications session is based, at least in part, on which features of a software application are invoked by the user.

13. The method of claim 8 comprising optionally removing the user from the social networking group when the user is not working with the software application.

14. The method of claim 7 wherein initiating the telecommunications session is based, at least in part, on an assessment of the user's proficiency of the software application.

15. The method of claim 7 wherein content is computer-readable source code and the characteristic of the content is the nature of the source code causing the user difficulty.

16. A method comprising:
receiving an assessment of the complexity of content associated with a software tool and a first user; and
initiating a telecommunications session between the first user and a second user who has been determined to be capable of working with content of similar complexity.

17. The method of 16 comprising:
receiving an assessment of the proficiency of a first user in using the software tool; and
wherein the second user is determined to be capable of working with content of similar complexity.

18. The method of claim 16 wherein the assessment of the proficiency of the first user is based, at least in part, on which features of the software application are invoked by the user.

19. The method of claim 16 wherein the content is computer-readable source code and the assessment of its complexity is based on a metric of the source code.

20. The method of claim 16 wherein the content is a sequence of actions taken by the first user in playing a computer game.
